(19) United States
(12) Patent Application Publication
(10) Pub. No.: US 2003/0041811 A1
(43) Pub. Date: Mar. 6, 2003

(54) Propeller harness truck tethering device

(76) Inventors: James C. Russell, Santa Rosa, CA (US); Roger La Forge, Santa Rosa, CA (US)

Correspondence Address: James C. Russell, 2054 Burbank Ave., Santa Rose, CA, 95407, US

(21) Appl. No.: 09/943,313

(22) Filed: Aug. 31, 2001

(51) Int. Cl. B60R 22/12; B60R 22/34

(52) U.S. Cl. 119/771

(57) ABSTRACT

This invention installs on the front rail of the bed of a pickup truck. It is intended to facilitate the safe transportation of one or two dogs.

The device incorporates a free-spinning propeller-type bar, mounted to a bracket in such fashion as to allow the tethers of one or tow dogs to be connected to it.

The device is a portable, easily installed mechanism, which incorporates the necessary components in one unit. It is unique insofar as no such ‘portable’ device currently exists.

### BACKGROUND OF THE INVENTION

1. Field of the Invention

This invention relates to the tethering of dogs within the bed of a pick-up truck, specifically to an improved method of tethering one or two dogs in such fashion as to minimize the risk of entanglement or other injury to dogs traveling in truck beds.

2. Description of the Prior Product Many dogs are injured each year because of unsafe tethering methods or total lack of tethering while riding on the bed of a pick-up truck. Injuries are typically result from three frequent occurrences:

1. Entanglement: Dogs often become entangled in their own leash, or in the leash of another dog riding the in the same vehicle.

2. Impact Injury: Dogs riding without tether are often thrown from the bed of a moving truck, or simply jump from the truck, usually resulting in death or serious injury.

3. Hanging: Dogs that are improperly tethered may jump over the side or back of the truck and hang themselves from their leash.

There are numerous existing devices that attempt to reduce the risk of injury to dogs riding in pick-up truck beds. The effectiveness of these devices is not questioned, nor are our claims based upon any assumption that current technology is deficient. However, we do believe that our invention offers improvement over existing technology.

### SUMMARY OF THE INVENTION

This device provides an improved and unique method of tethering one or two dogs in the bed of a pick-up truck.

The following features of this inventive apparatus are unique to this device, and are either not available or are not conveniently presented with other products:

1. This device incorporates the entire tethering mechanism in one central unit (other devices commonly employ multiple connection points). It can easily be installed to virtually any pick-up truck bed within a few minutes, with only minor modifications to the truck, and with only minor impact on the cargo area of the vehicle.

2. The device allows for the convenient tethering of one or two dogs in the same truck, in a fashion that allows a relatively wide range of motion and interaction between the dogs with minimal risk of entanglement.

3. The invention utilizes a rigid bar (the propeller harness), which rotates freely around a central axis point. Attached to each end of the bar is a rotating connecting point to which a cable tether is fastened. Each tether can be connected to the collar of one dog. If one dog jumps or climbs over or under the other dog, the propeller will revolve 180 degrees, allowing the position of both dogs' tethers to adjust to the new position of the dog, minimizing the risk of entanglement. Because of the specific length of each tether, it is impossible for either dog to jump or fall from the vehicle, or to hang him/herself

### BRIEF DESCRIPTION OF THE DRAWINGS

FIG. 1 is an exploded view of a preferred embodiment of a dog-tethering device of this invention that illustrates the mechanical construction of the device.

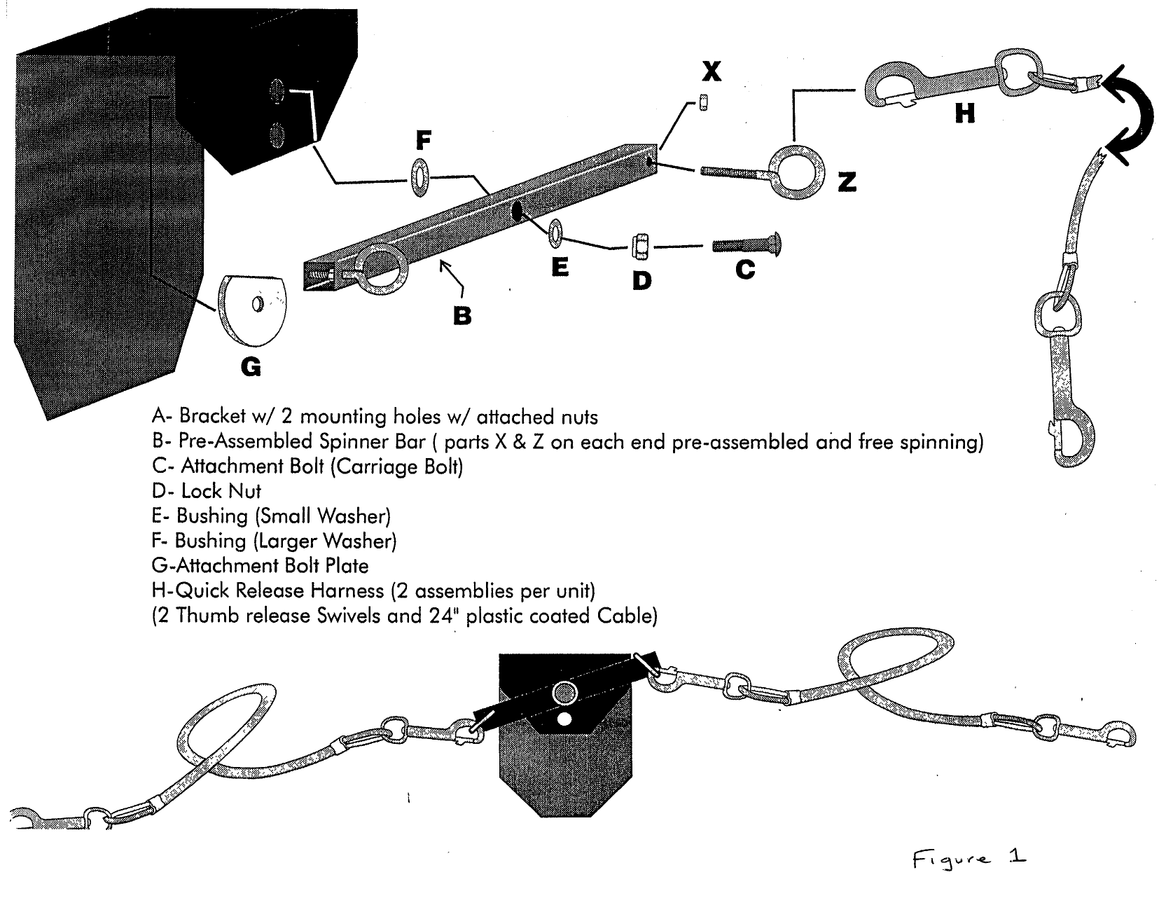

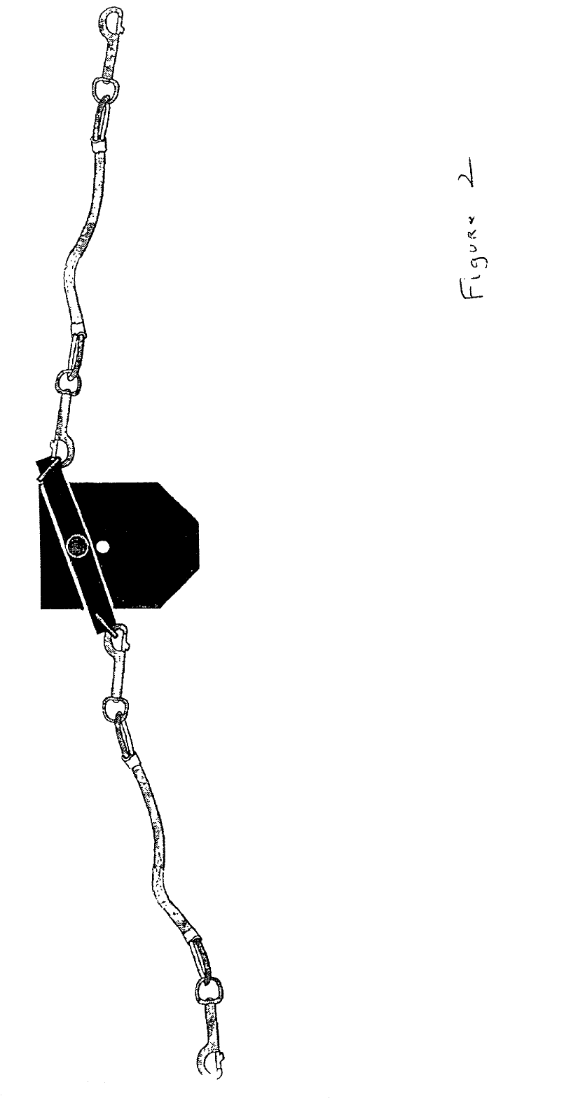

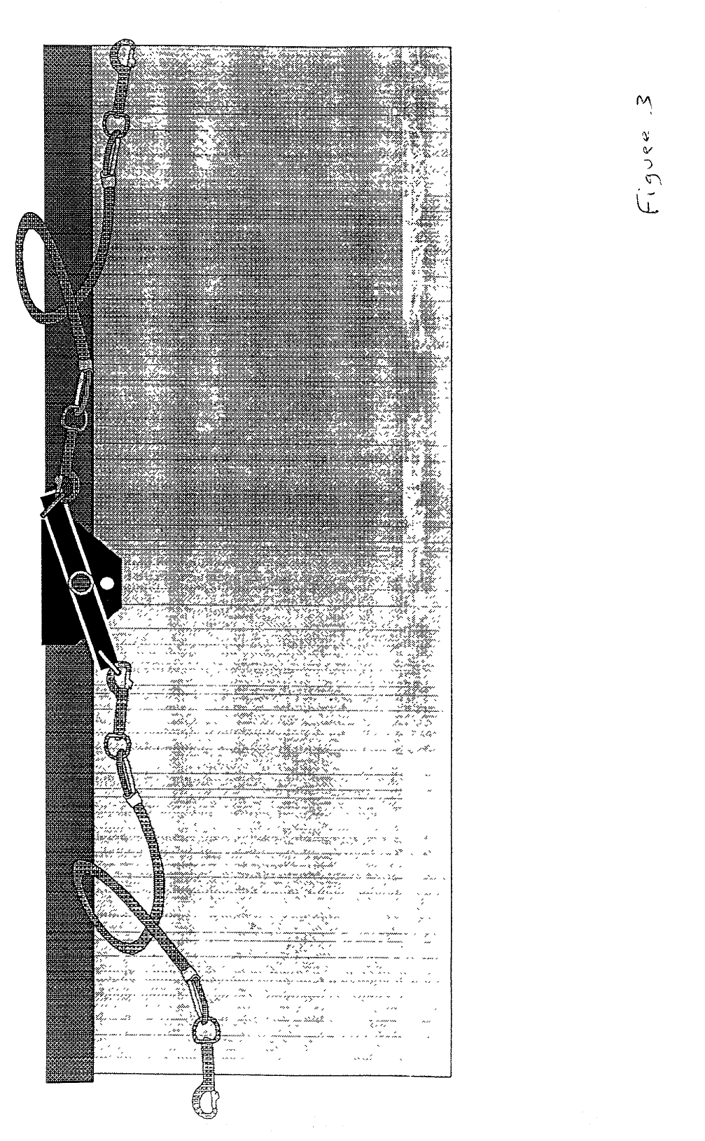

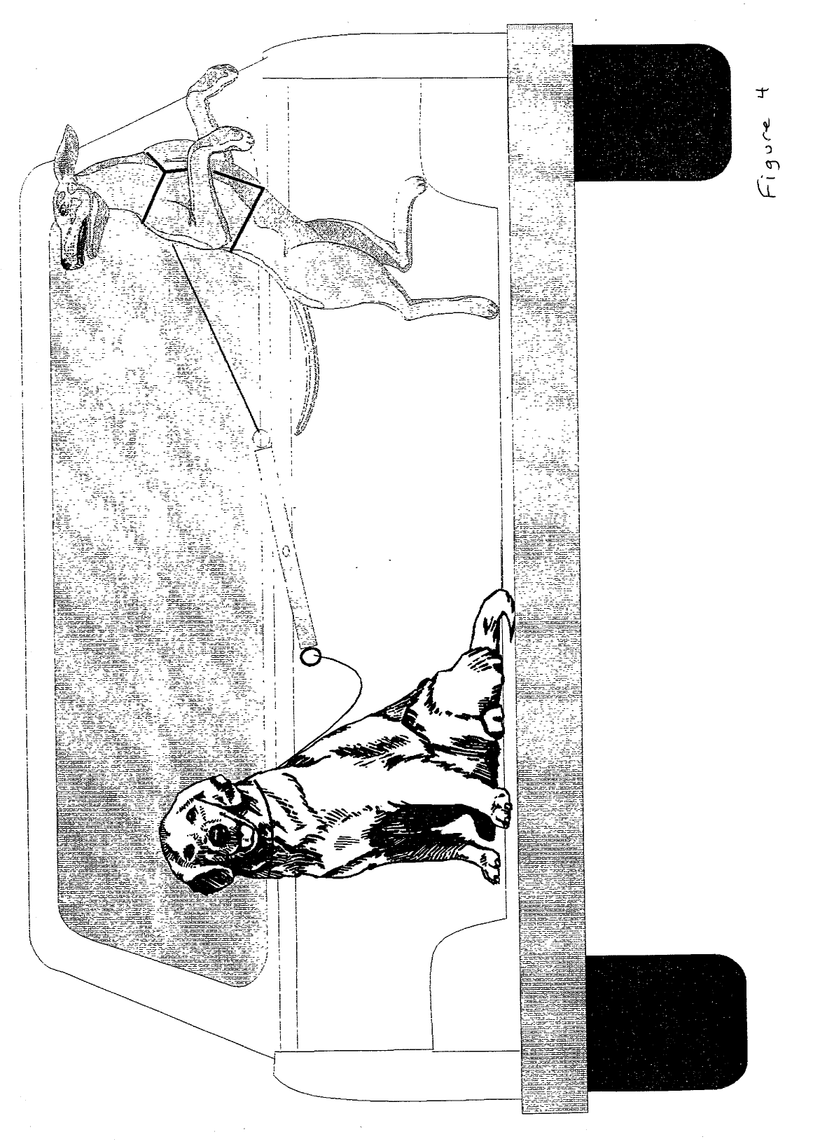

A. The mounting bracket to which the propeller harness is attached. This bracket slips over the front rail of the pick-up truck bed.

B. The propeller, or spinner bar, which spins on ‘C’ below.

C. The attachment bolt, which secures the propeller to bracket (A), and secures the bracket to the truck rail.

D. The lock nut, used to secure the propeller in its position.

E. A small washer, placed between the propeller and the lock nut.

F. A second, larger washer placed between the propeller and the bracket, to keep the propeller properly spaced from the bracket.

G. An attachment bolt plate, which fits at the end of the attachment bolt (C), against the surface of the front rail.

H. The tether comprised of cable, with swivel connectors secured to each end.

X. Eye bolts, secured to each end of the propeller. The tethers are secured to these bolts.

Z. Lock nuts are used to secure the eyebolts to the propeller.

FIG. 2 shows a frontal view of the mechanism with propeller and tethers attached. It illustrates the appearance of the device when installed and ready for use.

### DETAILED DESCRIPTION OF A PREFERRED EMBODIMENT

A preferred embodiment of this invention consists of a propeller harness system mounted to pressure bracket in the following fashion:

1. The pressure bracket is a ‘U’ shaped steel bracket, which drops over the top of the front rail of a pick-up truck.

2. A bolt is placed through a hole in the front plate of the bracket to allow the bracket to be securely clamped to the truck rail.

3. Revolving around the bolt is the propeller, a steel bar attached in such a fashion as to allow it to spin freely 360 degrees. Secured to each end of this propeller is an eyebolt, which is fastened so that it will spin freely 360 degrees.

4. A tether is connected to each eyebolt on the propeller. Attached at each end of the tether is a quick release spring clip.

5. Each tether can be connected to the collar of one dog.

While this device has been described in reference to preferred embodiments, design modifications can be made without departing from the utility and scope of the invention. Therefore, the scope of the invention is to be limited only by the accompanying claims.

1. A vehicle tether apparatus comprising of:
1. A C-shaped bracket capable of being placed over the top edge sidewall of the bed of a pick-up truck. The bracket consists of a long vertical plate, a shorter horizontal second plate, having one edge connected to the long vertical first plate, and a short vertical third plate opposite the long vertical first plate, having one edge connected to the shorter horizontal second plate, the short vertical third plate having a receiving hole in it.
2. A spinner bar having two ends and having two eyebolts affixed through the apparatus thereto, one each of the eyebolts being attached to one each of the two ends of said spinner bar, said spinner having central aperture through which an attachment bolt is passed to secure the spinner bar to the C-shaped bracket such that the spinner bar is capable of complete rotation.
3. At least one tether capable of being attached at one end to either of said eyebolts and at the opposite end to the collar of a pet.
